(19) United States
(12) Patent Application Publication
(10) Pub. No.: US 2006/0223404 A1
(43) Pub. Date: Oct. 5, 2006

(54) Textile mat and cushion made thereof and a method of making a cushion

(76) Inventor: Stig-Åke Gustafsson, Norrhult (SE)

Correspondence Address: HARNESS, DICKEY & PIERCE, P.L.C., P.O. BOX 8910, RESTON, VA, 20195, US

(21) Appl. No.: 10/541,537

(22) PCT Filed: Dec. 18, 2003
(86) PCT No.: PCT/SE03/01991

§ 371 Date: May 8, 2006

(30) Foreign Application Priority Data
Jan. 9, 2003 (SE) 0300028-8

(51) Int. Cl. D04H 13/00; B32B 5/26; B32B 5/06; D04H 1/46; D04H 1/00

(52) U.S. Cl. 442/327; 442/381; 442/387; 442/389; 442/390; 442/402; 442/403; 442/408; 442/414; 442/415; 442/416

(57) ABSTRACT

A textile mat, which is adapted to form a thermal comfort layer for a piece of seating or lying furniture and made of a moisture-permeable and a moisture-absorbing fibre layer, is made of biodegradable fibres only. Binder fibres are embedded in the moisture-absorbing fibre layer to keep it together and form an adhesive surface for keeping the two fibre layers together. A cushion is made of a textile body with a thermal and a biochemical comfort layer. The body is made in one piece of biodegradable fibres, the thermal comfort layer being formed of said textile mat and the biomechanical comfort layer being formed of a vertically pleated, set wadding. Biodegradable binder fibres are embedded in the wadding. In a method of making a cushion with a thermal and biomechanical comfort layer, a vertically pleated, set wadding is cut to a predetermined size. A textile mat is cut to the same size and placed on the wadding, whereupon the cut wadding and the cut textile mat are heated to a temperature at which the binder fibres melt, and are pressed together to the desired shape.

### TECHNICAL FIELD

The present invention relates to a textile mat which is adapted to form a thermal comfort layer for a piece of seating or lying furniture and which is made of a moisture-permeable and a moisture-absorbing fibre layer. The invention also relates to a cushion which is intended for a piece of seating or lying furniture and made of a textile body with a thermal and a biomechanical comfort layer, as well as a method of making a cushion with a thermal and a biomechanical comfort layer.

### TECHNICAL BACKGROUND

To provide seating comfort in a piece of upholstered furniture, a padding which has good thermal and biomechanical comfort properties is required. Thermal comfort relates to the padding's heat and moisture transport capacity and biomechanical comfort relates to the padding's flexibility, elasticity and contact pressure.

In former times, natural fibres were used as padding in seating furniture and mattresses. Old furniture with cushions, upholstered with natural fibre filling, is unelastic and incapable of recovering. Elasticity is provided by means of springs.

One of the currently most frequently used paddings is foamed polyurethanes which are formed by reaction between isocyanates and polyols. This results in a material which has good elasticity and which can be moulded in one piece to the desired shape. Such foamed materials are impervious and have poor thermal comfort properties. Polyurethanes are also used in gluing. In heating and burning, they release isocyanates which are dangerous to inhale and may cause, for instance, asthma and impaired lung function. Polyurethanes also constitute a problem in controlled dumping since they are not biodegradable and are dangerous to burn. In processing of the foamed materials, also freons are released, which influence the ozone content in the stratosphere and thus contribute to the thinning of the ozone layer. Attempts have therefore been made to replace them with environmentally friendly materials.

DE 42 06 895 discloses a textile flexible sheet material which has an outer layer and a moisture-absorbing inner layer, which are interconnected by means of a moisture-permeable connecting layer. Here, attempts seem to have been made to provide an environmentally friendly material since, inter alia, recycled fibres are used and recycling of the flexible sheet material is discussed. Nevertheless, the connecting layer is formed by flame doubling of soft foam of polyurethane. No alternative materials for the connecting layer are mentioned.

### SUMMARY OF THE INVENTION

The object of the invention is to provide in a simple manner an environmentally friendly textile mat and cushion completely without polyurethanes or chemicals injurious to health, said mat and said cushion, when arranged on a piece of seating furniture, affording good thermal comfort properties as well as good thermal and biomechanical properties. A further object of the invention is to provide a simple method of making, completely without polyurethanes, an environmentally friendly cushion with a thermal and a biomechanical comfort layer.

As to the textile mat, this object is achieved by means of a textile mat which is characterised in that it is made of biodegradable fibres only, and binder fibres are embedded in the moisture-absorbing fibre layer to keep it together and form an adhesive surface for keeping the two fibre layers together.

There are many aspects of environmental friendliness. Here, it is mainly referred to a material which is completely biodegradable, but according to the invention also the material contents of the product have been balanced for optimising the comfort properties with respect to a minimised environmental influence in the entire chain of manufacture. According to a preferred embodiment, the moisture-absorbing fibre layer of the textile mat therefore consists mainly of flax fibres, but it is also possible to use other fibres, such as sisal, hemp and nettles. The moisture-absorbing fibre layer preferably also comprises wool fibres which give a more elastic layer. The wool fibres also have naturally good flame-resistant properties. The binder fibres are preferably bicomponent fibres, which are made of polylactic acid and whose components have different melting temperatures. As a result, the fibres keep their fibre structure when the component with the lowest melting temperature melts and adheres to neighbouring fibres.

The moisture-permeable fibre layer of the textile mat preferably comprises hydrophobised flax fibres, but it is also possible to use other biodegradable fibres that do not absorb moisture.

The above object is achieved with respect to the cushion by means of a cushion which is characterised in that the body is made in one piece of biodegradable fibres, the thermal comfort layer being formed of a textile mat according to the invention and the biomechanical comfort layer being formed of a vertically pleated, set wadding, biodegradable binder fibres being embedded in the wadding to keep it together and form an adhesive surface for keeping said wadding and textile mat together.

Preferably, also the wadding consists mainly of flax fibres, and the binder fibres are melt fibres or bicomponent fibres.

The above object is achieved with respect to the method by means of a method which is characterised in that a vertically pleated, set wadding is cut to a predetermined size, and a textile mat according to the invention is cut to the same size and is placed completely overlappingly on the wadding, whereupon the cut wadding and the cut textile mat are heated in a heating step to a temperature at which the binder fibres melt, and are pressed together to the desired shape.

### DESCRIPTION OF PREFERRED EMBODIMENTS

A textile mat according to the invention consists of a hydrophobic moisture-permeable upper fibre layer and a moisture-absorbing lower fibre layer, which together form a thermal comfort layer in a chair cushion and which adhere to each other by means of binder fibres in the moisture-absorbing fibre layer. Both layers consist mainly of flax fibres.

The moisture-permeable fibre layer is preferably made of hydrophobised flax fibres, but it would also be possible to use some other biodegradable fibre with hydrophobic properties.

The moisture-absorbing fibre layer preferably comprises flax fibres, with a certain amount of wool added. Wool fibres give a more elastic material. This fibre layer can be needled or bonded in some other manner.

The textile mat is part of the padding, for instance, in a chair with an upholstered seat. The mat is adapted to be placed immediately under the covering of the chair, which must of course also be moisture permeable and which is a biodegradable surface layer, preferably a woollen, flax or viscous fabric.

According to the present invention, the binder fibre is a bicomponent fibre whose components have different melting temperatures. When heated to a temperature above the melting temperature of the component with the lowest melting temperature, this component will melt whereas the component with the highest melting temperature is unaffected, which makes the fibre keep its shape. The melted component makes the fibre become sticky and adhere to neighbouring fibres. The binder fibres are preferably formed of polylactic acid, a biodegradable polymer, which is made of starch, such as maize and potato. It is also possible to produce binder fibres of a vegetable oil, such as hemp seed oil.

Moisture produced by an individual sitting on the seat which is provided with the textile mat will be transported down through the covering of the chair and the hydrophobic, moisture-permeable fibre layer to the moisture-absorbing fibre layer where it is absorbed by the fibres thereof. The covering of the chair and the neighbouring fibre layer will thus remain dry, which gives the sitting person a pleasant sitting climate.

Under the moisture-absorbing fibre layer there is a biochemical comfort layer, i.e. a fibre layer which is adapted to have elastic and ventilating properties. This biomechanical comfort layer or elastic layer is preferably a vertically pleated and thermoset flax-non-woven wadding with embedded binder fibres. Such wadding is produced by vertical bonding, i.e. creasing of a wadding transversely to its feeding direction in such a manner that straight or inclined, transverse creases form, extending upwards from a horizontal plane, which are then thermoset. The creases formed are then arranged in the completed seat in such a manner that they are arranged essentially perpendicular to the seat surface.

A cushion according to the invention is preferably made of a body which is formed in one piece of the moisture-permeable fibre layer, the moisture-absorbing fibre layer and the elastic layer. The body is made by the different layers being cut to the same size and being placed completely overlappingly on each other in said order. Subsequently, they are introduced in a heating step into an oven and heated to a temperature at which the binder fibres melt. The three layers are simultaneously pressed together to the desired shape.

The binder fibres in the different layers of the cushion can be of different types or of the same type. The binder fibres can be single component melt fibres which completely melt in heating, or the above-described bicomponent fibres.

Preferably a biodegradable glue film and a biodegradable furniture fabric are cut and placed perfectly covering on the textile mat before the heating step. In this manner, a covered cushion can thus be provided while forming the cushion. Compared with prior-art methods, which include gluing and nailing of the furniture fabric to the cushion, this results in a more rational method of production.

1. A textile mat, adapted to form a thermal comfort layer for a piece of seating or lying furniture, the mat being made of a moisture-permeable and a moisture-absorbing fibre layer,
the mat being made of biodegradable fibres only, and the mat including binder fibres embedded in the moisture-absorbing fibre layer to keep it together and form an adhesive surface for keeping the two fibre layers together.

2. A textile mat as claimed in claim 1, in which the moisture-absorbing fibre layer consists mainly of flax fibres.

3. A textile mat as claimed in claim 1, in which the moisture-absorbing fibre layer comprises wool fibres.

4. A textile mat as claimed in claim 1, in which the binder fibres are melt fibres.

5. A textile mat as claimed in claim 4, in which the melt fibres are bicomponent fibres, whose components have different melting temperatures.

6. A textile mat as claimed in claim 1, in which the moisture-permeable fibre layer comprises hydrophobised flax fibres.

7. A cushion, intended for a piece of seating or lying furniture, the cushion including a textile body with a thermal and a biomechanical comfort layer, the body being made in one piece of biodegradable fibres, the thermal comfort layer being formed of a textile mat and the biomechanical comfort layer being formed of a vertically pleated, set wadding, biodegradable binder fibres being embedded in the wadding to keep it together and form an adhesive surface for keeping said wadding and textile mat together.

8. A cushion as claimed in claim 7, in which the wadding consists mainly of flax fibres.

9. A cushion as claimed in claim 7, in which the binder fibres are melt fibres.

10. A cushion as claimed in claim 9, in which the melt fibres are bicomponent fibres, whose components have different melting temperatures.

11. A method of making a cushion with a thermal and a biomechanical comfort layer, the method comprising:
cutting a vertically pleated, set wadding to a predetermined size;
cutting a textile mat to the same size; and
completely and overlappingly placing the mat on the wadding, whereupon the cut wadding and the cut textile mat are heated to a temperature at which the binder fibres melt, and are pressed together to the desired shape.

12. A textile mat as claimed in claim 2, in which the moisture-absorbing fibre layer comprises wool fibres.

13. A textile mat as claimed in claim 2, in which the binder fibres are melt fibres.

14. A textile mat as claimed in claim 3, in which the binder fibres are melt fibres.

15. A textile mat as claimed in claim 2, in which the moisture-permeable fibre layer comprises hydrophobised flax fibres.

16. A cushion as claimed in claim 7, in which the thermal comfort layer is formed of a textile mat made of a moisture-permeable and a moisture-absorbing fibre layer, made of biodegradable fibres only, and including binder fibres embedded in the moisture-absorbing fibre layer to keep it together and form an adhesive surface for keeping the two fibre layers together.

17. A cushion as claimed in claim 8, in which the binder fibres are melt fibres.

18. A cushion as claimed in claim 17, in which the melt fibres are bicomponent fibres, whose components have different melting temperatures.

19. A method as claimed in claim 11, in which the mat is made of a moisture-permeable and a moisture-absorbing fibre layer, the mat being made of biodegradable fibres only, and the mat including binder fibres embedded in the moisture-absorbing fibre layer to keep it together and form an adhesive surface for keeping the two fibre layers together.
